(19) United States
(12) Patent Application Publication
(10) Pub. No.: US 2004/0167014 A1
(43) Pub. Date: Aug. 26, 2004

(54) Nanostructured proton exchange membrane fuel cells

(75) Inventors: Yushan Yan, Riverside, CA (US); Cheng Wang, Riverside, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the Univ. of California, Office of Technology Transfer, University of California, Oakland, CA (US)

(21) Appl. No.: 10/713,774

(22) Filed: Nov. 13, 2003

Related U.S. Application Data
(60) Provisional application No. 60/425,934, filed on Nov. 13, 2002.

(51) Int. Cl. B05D 5/12; H01M 4/88

(52) U.S. Cl. 502/101; 427/115

(57) ABSTRACT

A novel proton exchange membrane fuel cell with nanostructured components with higher precious metal utilization rate at the electrodes, higher power density, and lower cost. Aligned arrays of carbon nanotubes, either single wall or multiwall, are prepared by catalyzed chemical vapor deposition (CVD), or plasma assisted CVD and used as support for catalyst. Solubilized perfluorosulfonate ionomer membrane is incorporated into the spare space between nanotubes to form a 4-phase boundary of gas, metal, proton conductor, and electron conductor. By assembling the as-prepared electrodes with perfluorosulfonate ionomer membrane, backing layers and electron collectors, proton exchange membrane fuel cells are developed.

### CROSS-REFERENCES TO RELATED APPLICATIONS

This application claims the benefit of U.S. Provisional Patent Application No. 60/425,934, filed Nov. 13, 2002, which application is incorporated herein by reference in its entirety for all purposes.

### BACKGROUND OF THE INVENTION

The present invention relates to the field of proton exchange membrane fuel cells (“PEMFC”), and in particular to carbon nanotube-based electrodes and membrane electrode assemblies for such fuel cells.

Fuel cells are electrochemical devices that convert chemical energy directly into electrical energy. Compared with internal combustion engines, fuel cells are not limited by the Carnot cycle and in principle could have higher efficiency. With pure hydrogen as the fuel, fuel cells are very environmentally friendly. The combination of high efficiency, low environmental impact, and high power density has been and will continue to be the driving force for vigorous research in this area for a wide variety of applications such as transportation, residential power generation, and portable electronic applications. For portable electronic applications, important features include high power density (i.e., longer battery life) and compactness.

Silicon-based microfabrication technology is amongst the promising approaches for fabrication of compact micro fuel cells. However, the current methods for making electrodes for fuel cells, which typically includes spraying and/or brushing of platinum (“Pt”) supported on carbon powder, is incompatible with microfabrication techniques. Therefore, there is need for improved electrodes and methods of preparing such electrodes for PEMFCs.

### BRIEF SUMMARY OF THE INVENTION

This invention provides a proton exchange membrane fuel cell with nanostructured components, in particular, the electrodes. The nanostructured fuel cell has a higher precious metal utilization rate at the electrodes, higher power density (kW/volume and kW/mass), and lower cost. The nanostructured fuel cells are not only attractive for stationary and mobile applications, but also for use as a compact power supply for microelectronics such as laptops, cell phones and other electronic gadgets. In accordance with one embodiments of the present invention, aligned arrays of carbon nanotubes are prepared by catalyzed chemical vapor deposition (CVD), or plasma assisted CVD and used as support for catalyst. The aligned array of carbon nanotubes include single walled or multiwalled tubes, which are produced by templated CVD or plasma assisted CVD. The precious metal is deposited either through the normal impregnation, or it is deposited by electrodeposition. After depositing precious metal(s), a solubilized perfluorosulfonate ionomer (e.g., Nafion) is incorporated into the spare space between nanotubes to form a 4-phase boundary (gas, metal, proton conductor, and electron conductor). By assembling the as-prepared electrodes with a membrane, gas diffusion layers and electron collectors, proton exchange membrane fuel cells are developed.

In accordance with another embodiment of the present invention, an array of nanotubes is directly deposited on a carbon paper by a catalyzed CVD process. Carbon nanotubes are selectively grown directly on the carbon paper by chemical vapor deposition with an electrodeposited catalyst such as cobalt, iron or other catalysts catalyzing the growth of the carbon nanotubes. The as-prepared carbon nanotubes are employed as the support for the subsequent precious metal (e.g., platinum, gold, or other precious metal) catalyst, which is electrodeposited on the carbon nanotubes. After depositing precious metal(s), a solubilized perfluorosulfonate ionomer (e.g., Nafion) is incorporated into the spare space between nanotubes to form a 4-phase boundary (gas, metal, proton conductor, and electron conductor). By assembling the as-prepared electrodes with a membrane, gas diffusion layers and electron collectors, proton exchange membrane fuel cells are developed.

Alternately, in accordance with the embodiments of the present invention, instead of incorporating an ionomer into the spare spaces between the nanotubes, the electrode is formed by organically functionalizing the nanotubes to make them proton conductive. For example, the nanotubes may be sulfonic acid functionalized using known standard chemistries.

The advantages of the embodiments of the present invitation include applying modern nano technologies such as template-controlled synthesis of nanostructured carbon nanotubes to fuel cells, CVD growth of carbon nanotubes with electrodeposited catalysts, such as iron, cobalt and many other known catalysts, thus leading to high power density and lower cost.

For a further understanding of the nature and advantages of the invention, reference should be made to the following description taken in conjunction with the accompanying figures. It is to be expressly understood, however, that each of the figures is provided for the purpose of illustration and description only and is not intended as a definition of the limits of the embodiments of the present invention.

### BRIEF DESCRIPTION OF THE DRAWINGS

FIG. 1 is an exemplary diagram of a silicon-based micro fuel cell in accordance with an embodiment of the present invention;

FIG. 2 is an exemplary diagram of electrochemical reactions in the anode and the cathode;

FIG. 3 is an exemplary diagram of the preparation steps for the aligned carbon nanotube array catalyst for a membrane electrode assembly;

FIG. 4 is a SEM image of an anodic porous alumina;

FIG. 5 is a SEM image of hexagonally aligned arrays of multiwalled carbon nanotubes;

FIGS. 6A-B are SEM micrographs of carbon paper after electrodeposition of Co: A) with 0.26 mg/cm2 Co (inset is bare carbon paper) and B) with 4 mg/cm2 Co (inset is 20 mg/cm2 Co);

FIGS. 7A-D are SEM and TEM micrographs of MWNTs grown by 0.26 mg/cm³ Co loading on carbon paper; A) SEM with low magnification showing high coverage of MWNTs on carbon paper; B) SEM with higher magnification showing the diameter of the MWNTs and presence of Co catalyst particles; C) TEM of MWNTs, D) SEM of Pt particles electrodeposited on MWNTs;

FIG. 8 is a cyclic voltammetry in a K₃Fe(CN)₆ solution (5 mM K₃Fe(CN)₆+0.5 M K₂ SO₄) of: 1) 3.46 cm2 of carbon paper alone; 2) MWNTs grown by 0.26 mg/cm² Co loading covering the same 3.46 cm² carbon paper. Scan rate: 50 mV/s;

FIG. 9 is a polarization curve of an MEA prepared by electrodeposition of Pt on MWNTs grown by 0.26 mg/cm² Co loading. Pt loading on both electrodes: 0.2 mg/cm². Membrane: Nafion 115. Operating conditions: cell temperature, 70° C.; humidifier temperature, 80° C.; pressure, 2 atm.

### DETAILED DESCRIPTION OF THE INVENTION

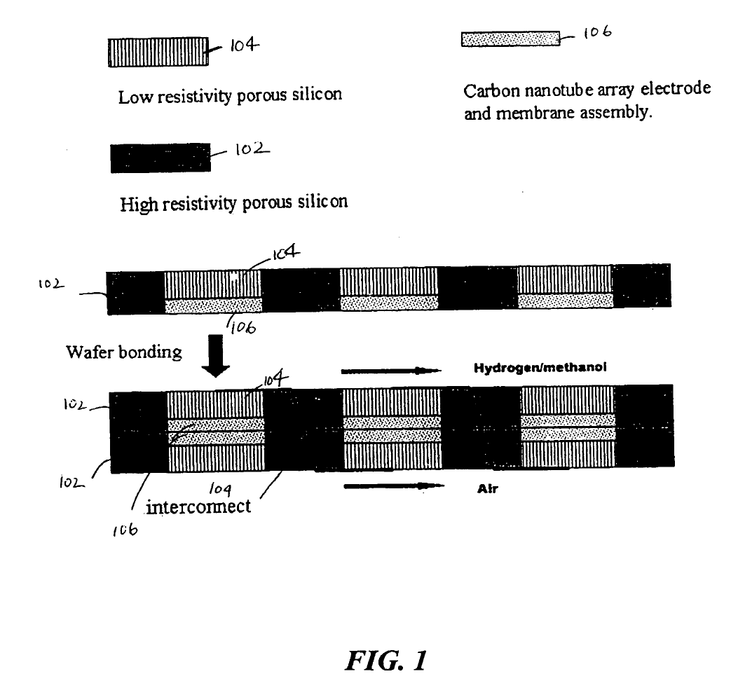

FIG. 1 is an exemplary diagram of a silicon-based micro fuel cell in accordance with an embodiment of the present invention. As is shown in FIG. 1 a silicon-based micro fuel cell include a high resistivity porous silicon region 102 next to a stacked arrangement of a carbon nanotube array electrode and membrane assembly 106 and a low resistivity porous silicon region 104. This arrangement can be repeated to achieve desired power outputs. Nearly identical arrangements are then coupled to another and arranged for fuel cell operation.

Typically, a PEMFC consists of an anode, a cathode, and a proton exchange membrane (PEM). The assembly of these three components is usually called a membrane electrode assembly (MEA). If pure hydrogen is used as fuel, hydrogen is oxidized in the anode and oxygen is reduced in the cathode. The protons and electrons produced in the anode are transported to the cathode through the proton exchange membrane and external conductive circuit, respectively. Water is produced on the cathode as a result of the combination of protons and oxygen.

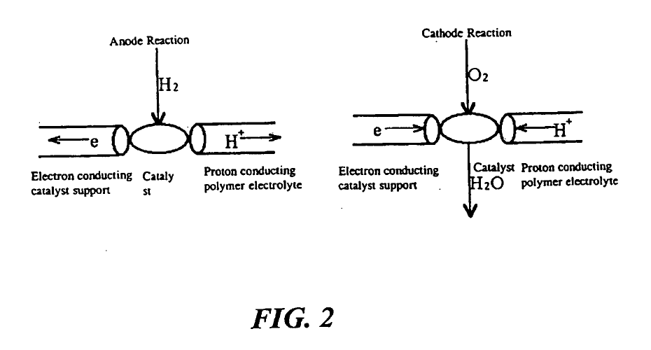

A concern when developing improved fuel cells, is to develop highly efficient electrodes that are inexpensive and compatible with silicon-based microfabrication technology. As shown in FIG. 2, an effective electrode in a PEMFC requires a 4-phase-boundary (QPB) in the catalyst layer. A preferred QPB allows the facile transport of reactant gases (hydrogen and/or oxygen), facile transport of electrons to/from the external circuit and protons to/from the PEM. In order to make the catalyst accessible by reactant gases, a hydrophobic diffusion layer consisting of carbon particles and polytetrafluoroethylene (PTFE) is usually used to manage the water content around the catalyst layer.

At present, the most commonly used electrode catalyst is Pt supported on carbon particles. One of the challenges in the commercialization of PEMFCs is the high cost of noble metals used as catalyst (e.g., Pt). Decreasing the amount of Pt used in a PEMFC via the increase of the utilization efficiency of Pt has been one of the major concerns during the past decade. To effectively utilize the Pt catalyst, the Pt should have simultaneous access to the gas, the electron-conducting medium, and the proton-conducting medium. In the catalyst layer of a Pt-based conventional fuel cell prepared by the ink-process, the simultaneous access of the Pt particle by the electron-conducting medium and the proton-conducting medium is achieved via a skillful blending of Pt-supporting carbon particles and the solubilized perfluorosulfonate ionomer (e.g., Nafion). The carbon particles conduct electrons and the perfluorosulfonate ionomer (e.g., Nafion) conduct protons. However, even with the most advanced conventional electrodes, there is still a significant portion of Pt that is isolated from the external circuit and/or the PEM, resulting in a low Pt utilization. For example, Pt utilization in current commercially offered prototype fuel cells remains very low (20-30%) although higher utilization has been achieved in laboratory devices. Efforts directed at improving the utilization efficiency of the Pt catalyst have focused on finding the optimum material configurations while minimizing the Pt loading and satisfying the requirements of gas access, proton access, and electronic continuity. In the conventional ink-process, a common problem has been that the necessary addition of the solubilized perfluorosulfonate ionomer (e.g., Nafion) for proton transport tends to isolate carbon particles in the catalyst layer, leading to poor electron transport.

Due to their unique structural, mechanical, and electrical properties, carbon nanotubes have been recently proposed to replace traditional carbon powders in PEMFCs and have been demonstrated by making membrane electrode assemblies (MEA) using carbon nanotube powders through a conventional ink process. However, their results did not show many advantages over carbon black (Vulcan XC-72) since the Pt utilization within the PEMFC catalyst layer remained unaddressed. Growing carbon nanotube arrays directly on the carbon paper and then subsequently electrodepositing the Pt selectively on the carbon nanotubes improves the Pt utilization, thus securing the electronic route from Pt to the electron collecting layer in a PEMFC. The use of carbon nanotubes and the resulting guaranteed electronic pathway eliminate the previously mentioned problem with conventional PEMFC strategies where the proton conducting medium (e.g., Nafion) would isolate the carbon particles in the electrode layer. Eliminating the isolation of the carbon particles supporting the electrode layer improves the utilization rate of Pt.

Generally, there are two categories of carbon nanotubes: single-walled nanotubes (SWNTs) and multi-walled nanotubes (MWNTs). A SWNT is a single graphene sheet rolled into a cylinder. A MWNT is comprised of several coaxially arranged graphene sheets rolled into a cylinder. According to theoretical predictions, SWNTs can be either metallic or semiconducting depending on the tube diameter and helicity. The band gap is proportional to the reciprocal diameter, 1/d. For MWNTs, scanning tunneling spectroscopy (STS) measurements indicate that the conduction is mainly due to the outer shell, which are usually much larger than SWNTs. Therefore, MWNTs have a relatively high electrical conductivity. And, it is preferred that MWNTs be the support for the Pt catalyst in PEMFCs because of their relatively high electrical conductivity and because current growth methods for MWNTs are simpler than those for SWNTs.

Various production methods such as arc discharge, laser ablation, chemical vapor deposition, and template synthesis techniques have been used to obtain carbon nanotubes in single walled, multi walled or disordered walled form. In general, the tube diameters are known to be difficult to control. The carbon nanotubes are often obtained as a powder with separate or entangled nanotubes that exhibit a broad distribution in tube diameter. Some of the single-wall nanotubes undergo self-organization to a bundle. However, the organization is achieved through weak van der Waals interaction, and therefore the bundle may not be considered as a system with rigid structural periodicity. There have been numerous studies describing the properties of aligned arrays of multi walled carbon nanotubes (AAMWNTs) and that they offer many advantages over randomly oriented MWNTs in a variety of applications including electron field emitters. Aligned arrays of multi walled carbon nanotubes (AAMWNTs) have been obtained previously by using chemical vapor deposition (CVD) over catalysts embedded in mesoporous silica, over laser-patterned catalyst on silica, on patterned porous silicon and plain silicon substrates, on patterns created on silica and silicon surfaces, on glass substrates, and within the pores of anodic porous alumina (APA) templates. For certain conditions, AAMWNTs prepared in APA templates is preferred as the catalyst support after removal of the alumina, because spaces around the nanotubes are available and can be controlled for introduction of solubilized perfluorosulfonate ionomer (e.g., Nafion) nanoparticles and for the diffusion of reactant gases. All of these ensure the formation of QBP in the catalyst layer for PEMFCs.

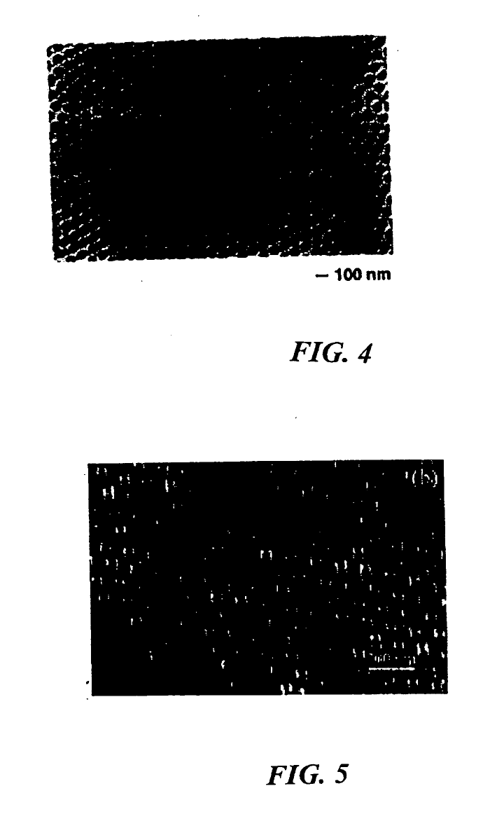

Porous oxide growth on aluminum under anodic bias in various electrolytes has been studied for almost half a century. Because of their relatively regular structure with narrow pore size distribution and interpore spacing, APA membranes were used for fabrication of nanometer scale composites. The quality of the APA film depends on many factors in the preparation process. O. Jessensky et al. [Jessensky O.; Müller F.; Gösele U.; Self-organized formation of hexagonal pore arrays in anodic alumina, Appl. Phys. Lett. 1998, 72:1173-1175] found that the aluminum should be annealed and electropolished before oxidation, otherwise the porous alumina membrane would not exhibit any ordered pore domains. In the anodization process, the temperature, agitation, anodization time and voltage are controlled in order to obtain high quality arrayed porous alumina. The film thickness is proportional to anodizing time and the pore diameter and interpore distance increase linearly with the applied anodization voltage. After anodization, the porous film can be removed from un-anodized aluminum by immersion in saturated HgCl₂ solution. FIG. 4 shows an example of APA prepared by O. Jessensky et al. In one embodiment of the present invention, such a template is used to form an aligned array of nanotubes as is disclosed below.

However, there are two concerns of using the normal porous alumina on aluminum to form APA templates for implementation into the methods disclosed herein. First, although the un-anodized aluminum metal could be easily removed by a post-treatment with HgCl₂ solution, there remains an insulating alumina layer at the bottom of each hole which can prevent a proper electrodeposition of catalyst for CVD formation of carbon nanotubes. Second, the thermal stability of the so-formed porous alumina at high temperature is not very high. This may pose a problem for carbon nanotube formation because carbon nanotubes are usually prepared above 700° C. Iwasaki et al. used a base layer of Nb, which has a comparable thermal expansion coefficient to APA, as the substrate for anodic alumina. They observed that APA on Nb could offer the durability for high temperature processes. Also by having a composite substrate (e.g., Al on Nb), there will be no insulating layer at the bottom of pores after anodization. Thus, the electrodeposition of catalyst for nanotube formation is achievable.

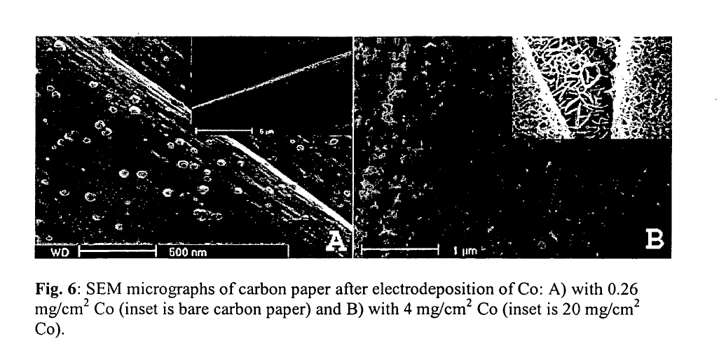

Aligned arrays of multiwalled carbon nanotubes (AAMWNTs) have been successfully prepared on silicon and mesoporous silica. FIG. 5 is an example of this kind of carbon nanotubes made in APA. When using porous silicon as substrates, the substrates were obtained by electrochemical etching of n-type silicon wafers in HF/methanol solutions. During the CVD growth, the outermost walls of nanotubes interact with their neighbors via van der Waals forces to form a rigid bundle, which allows for the growth of nanotubes perpendicular to the substrate. In the case of mesoporous silica, the mesoporous silica containing iron nanoparticles was prepared by a sol-gel process from tetraethoxysilane (TEOS) hydrolysis in iron nitrate aqueous solution. The iron ions were converted to highly catalytically active iron nanoparticles upon reduction at 550° C. in flowing 9% H₂/N₂. Subsequently, a CVD method using 9% acetylene in nitrogen as carbon source was applied to produce carbon nanotubes. SEM images show that the nanotubes were approximately perpendicular to the surface of the silica and form an aligned array of isolated tubes with spacing between the tubes of about 100 nanometers. Although these approaches provide AAMWNTs on the surface or in the holes of a template, the nanotubes prepared in APA are more promising as catalyst supports in fabricating the catalyst layer for PEMFCs because the diameter, length and spacing between carbon nanotubes all can be easily controlled by the APA template.

As set forth above, the conductivity of MWNTs depends on the diameter and helicity of the outer shells, among which normally one third are metallic and electron conductive. However, since the diameters of the outer shells are usually large enough the band gap of those semiconducting outer shells is very small and can be used as conductive catalyst supports. Carbon nanotubes doped with boron have been demonstrated to significantly increase the conductivity of carbon nanotubes and can be used as the catalyst support.

The tips of the nanotubes prepared in APA could be either closed or opened depending on the synthetic condition. The inner cavity of opened carbon nanotubes could be used as the host of some metal particles. Since the diameter of this cavity is less than 4 nm and solubilized Nafion has a molecular weight of 1100 and an average aggregate size of 50 Å, a QPB is not expected to be formed in this inner region. To avoid the deposition of catalyst particles in the inner cavity of carbon nanotubes, nanotubes with closed caps are preferred.

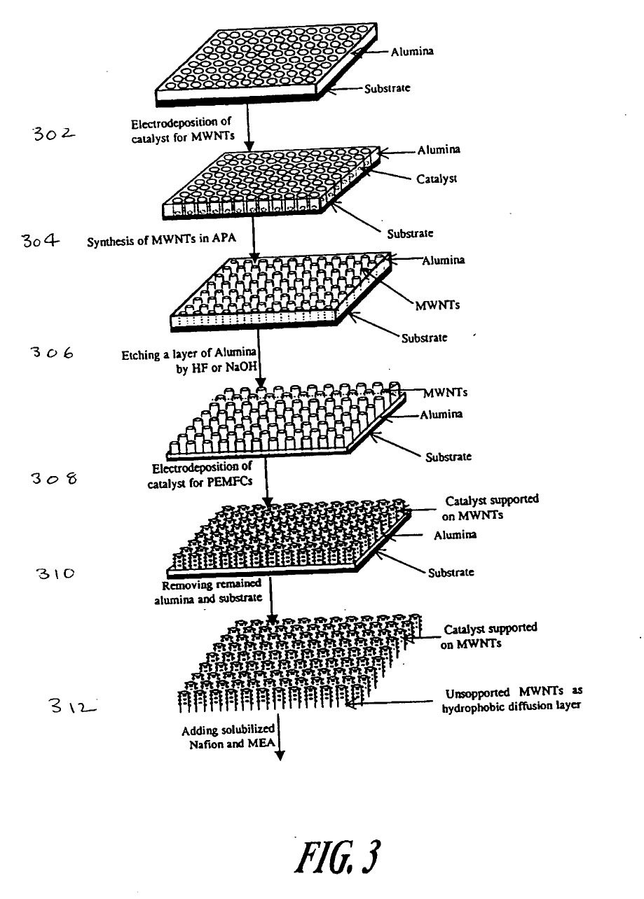

FIG. 3 is an exemplary diagram of the preparation steps for the aligned carbon nanotube array catalyst for a membrane electrode assembly. Catalysts for nanotube formation are electrodeposited to the bottom of each pore in the porous alumina template (302). Such catalysts include cobalt, iron and other catalysts. After catalyst deposition, carbon nanotube arrays are fabricated by CVD (304). Then the upper part of the alumina template will be removed by etching in HF or NaOH (306). The etching time is controlled so that a thin layer (e.g., 5 μm thick) of alumina will be left. The layer will prevent Pt deposition on this portion of the carbon nanotube in the next step. Eventually, this layer will be removed after the Pt deposition leaving a hydrophobic region without Pt particles. The benefit of this section of the tube is its hydrophobicity and this should help manage the water content in the catalyst layer.

High metal dispersion is an important design factor for any catalyst. In fuel cells, the high loading of expensive Pt on carbon black has limited their widespread use. This motivated numerous studies to improve metal dispersion on carbon, mainly through optimization of the preparation procedures or functionalization of the carbon surface. In the embodiments of the present invention, carbon nanotubes are used as catalyst supports. Pt can be loaded on carbon nanotubes by an incipient-wetness procedure. The resulting materials did support a high dispersion of platinum nanoparticles, exceeding that of other common microporous carbon materials (such as carbon black, charcoal and activated carbon fibers). However, in the catalysts produced by incipient-wetness method, the adhesion of the metal nanoparticles to the carbon nanotubes is not very strong; perhaps because the interaction is mainly van der Waals forces. These physisorbed metal nanoparticles may easily detach from the substrates and agglomerate in further treatment. In addition, it is difficult to control the homogeneity of metal deposition on the surface by this incipient-wetness method. An accepted solution to this difficulty is to functionalize the surface of the carbon nanotubes. Generation of functional groups on the surface of carbon nanotubes can be realized through chemical oxidation treatments. Electron-energy-loss spectroscopy (EELS) indicates chemical bonding between Pt and the SWNT surfaces. Such surface functionalization enhances the reactivity, improves the specificity, and provides an avenue for further chemical modification of the carbon nanotubes, such as ion adsorption, metal deposition and grafting reaction.

An alternative to this functionalization for metal deposition is electrochemical reduction. In one study, the electroreduction of platinum from solution onto glassy carbon substrates and into PEMFCs power carbon/carbon cloth electrodes has been demonstrated. Aligned multiwalled carbon nanotubes have been used to make conducting polymer-carbon nanotube (CP-NT) coaxial nanowires by electrochemical deposition of a concentric layer of an appropriate conducting polymer uniformly onto each of the constituent aligned nanotubes. It was also shown that homogeneous films of aligned carbon nanotubes can be produced on quartz glass plate by pyrolyzing iron (II) phthalocyanine (Fe C₃₂N₈H₁₆, designed FePc) under Ar/H₂ at 800-1100° C. and more importantly the as-synthesized aligned-nanotube film can be transferred to a gold substrate with full integrity so that electrochemistry can be carried out. The transmission electron microscope (TEM) images taken at the tip and on the wall of a CP-NT coaxial nanowire show a homogeneous polymer coating. To construct a gold-supported nanotube film for electrochemical generation of the CP-NT coaxial nanowires, a thin film of gold (about 5 μm) was sputtered onto the amorphous carbon layer covering an as-synthesized aligned nanotube film that was then separated from the quartz glass plate used in the preparation of the nanotube film with an aqueous solution of HF (30% w/w).

After Pt deposition (308) solubilized perfluorosulfonate ionomer (e.g., Nafion) nanoparticles are introduced into the aligned arrays of multiwalled carbon nanotubes films to make the catalyst layer by impregnation. After removing the remaining thin alumina layer and the metal substrate (310) (Nb), carbon paper or cloth, which is the backing layer, and a proton exchange membrane PEM will be added (312). An MEA is completed by hot pressing. Alternately, in accordance with the embodiments of the present invention, instead of incorporating an ionomer into the spare spaces between the nanotubes, the electrode is formed by organically functionalizing the nanotubes to make them proton conductive. For example, the nanotubes may be sulfonic acid functionalized using known standard chemistries.

In an alternate embodiment of the present invention, carbon nanotubes are formed directly on a carbon substrate, i.e., without using an APA template as disclosed above, as is set forth below.

### EXAMPLES

The following examples are provided to illustrate the embodiments of the present invention. They are not intended to limit the scope of this disclosure to the embodiments exemplified therein. All ranges for all parameters disclosed are inclusive of the range limits.

### Example

### Preparation of Multi-Walled Carbon Nanotubes as Platinum Support for PEMFCs

In this example, carbon nanotubes were selectively grown directly on the carbon paper by chemical vapor deposition with electrodeposited cobalt catalyzing the growth of the carbon nanotubes. Alternate catalysts such as iron, and so on may also be used for the growth of the nanotubes. The as-prepared carbon nanotubes were employed as the support for the subsequent platinum catalyst, which was electrodeposited on the carbon nanotubes. In addition to cobalt, other catalysts such as Fe may be used. This non-ink process ensures that all of the electrodeposited Pt catalyst particles are electronically accessible to the external circuit of a PEMFC.

The Co catalyst for MWNT growth was electrodeposited on one side of the carbon paper by a three-electrode dc method in a 5 wt. % CoSO₄ and 2 wt. % H₃BO₃ aqueous solution at 20° C. The deposition potential used was −1.2 V vs. SCE (saturated calomel electrode, Aldrich) and the loading was controlled by the total charge applied. The Co loading that was used to make the membrane electrode assembly was 0.26 mg/cm² resulting from a total applied charge of 2 coulombs. FIG. 6 shows the SEM (Philips XL30-FEG) images of the carbon paper with and without electrodeposited Co. The carbon paper is made of fibers having a diameter between 5 and 10 μm (inset in FIG. 6A) and the surface of the carbon fiber is clean before deposition. The contact angles for carbon paper by double distilled water are around 104.5°, as determined from the hydrophobic test (VCA-Optima). This hydrophobic property enables the selective deposition of Co on the side of the carbon paper facing the electrolyte solution, which also makes it possible for selective growth of MWNTs on one side of carbon paper. This is also preferred for fuel cell applications because further selective deposition of Pt catalyst becomes feasible. After applying 2 coulombs charge on 2.55 cm² circular carbon paper for depositing cobalt, which equals 0.26 mg/cm² of Co loading assuming 100% yield of the electrodeposition, nanocrystalline Co could be found on the surface of carbon fibers (FIG. 6A). The particle size is in the range of 20 to 50 nm. With the increase of Co loading, the particle size increases. Dendrimetric nanocrystalline Co (FIG. 6B) were observed when the loading was 4 mg/cm². Further increases in loading, for example to 20 mg/cm² as shown in the inset of FIG. 6B, made it possible to cover and connect the carbon fibers on the whole surface of carbon paper by a porous Co structure.

A feature of MWNTs is their high surface area for subsequent Pt deposition. Considering the fact that small catalyst particles are beneficial for the growth of MWNTs with small diameters (therefore high surface area), a loading of 0.26 mg/cm² Co on carbon paper was employed in all of the examples described below, unless otherwise stated. For the MWNT growth, CVD was employed due to its suitable growth temperature and scalability. The MWNTs were grown as follows. Carbon paper with Co electrodeposited on one side of the paper was placed in a furnace at ambient pressure and heated to 550° C. in 3 hrs under a 150 sccm (standard cubic centimeters per minute) N₂ flow and 7.5 sccm H₂ flow. These conditions were maintained for 30 minutes. The temperature was then raised to 700° C. over a 30 minute time interval. Upon reaching 700° C., acetylene was introduced at 7.5 sccm for 1 hr to facilitate MWNT growth. Finally, the acetylene and H₂ flow was cut off and the furnace cooled to room temperature under 150 sccm N₂.

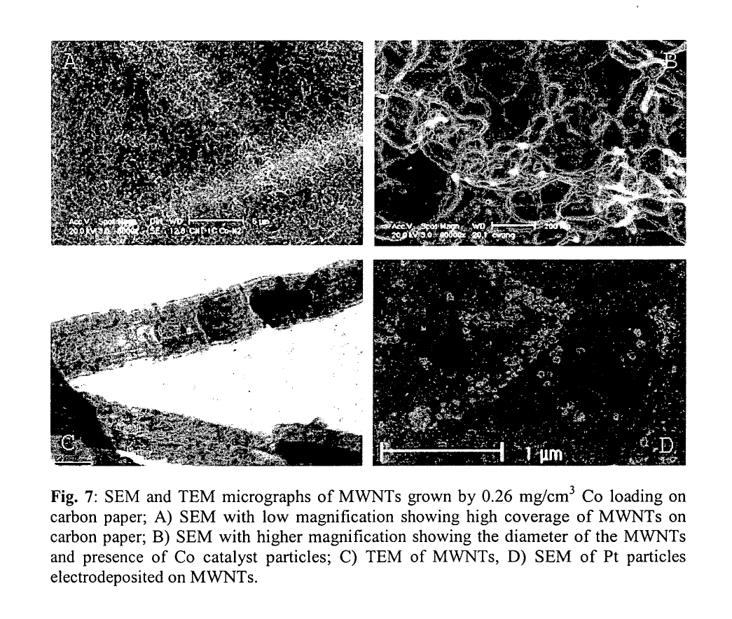

FIG. 7 presents the SEM and TEM pictures of the resulting MWNTs after CVD growth using a 0.26 mg/cm² Co loading. As shown in FIG. 7A, a thin layer of MWNTs covers the carbon paper. The as-prepared MWNTs are wavy with lengths in the micrometer range and diameters in the range of 20 to 40 nm (FIG. 7B). Some bright particles on MWNTs can also be observed from FIG. 7B, which were identified as Co under electron diffraction x-ray spectroscopy (EDX). The TEM (Philips CM300) image in FIG. 7C shows two MWNTs with outer shell diameters of 30 and 40 nm along with some metal particles present in the inner cavity of the MWNTs. The inner diameters of the MWNTs are about 10 nm.

Following the CVD growth of the MWNTs, Pt was electrodeposited on the MWNTs by a three-electrode dc method in 5 mM H₂PtCl₆ and 0.5 M H₂SO₄ aqueous solution. The deposition potential used was 0 V vs. SCE and the loading of Pt was controlled by the total charge applied. FIG. 7D shows the SEM image of the Pt electrodeposited on the MWNTs. The average diameter of these particles is about 25 nm. The successful deposition of Pt indicates a good electrical contact between the MWNTs and the substrate.

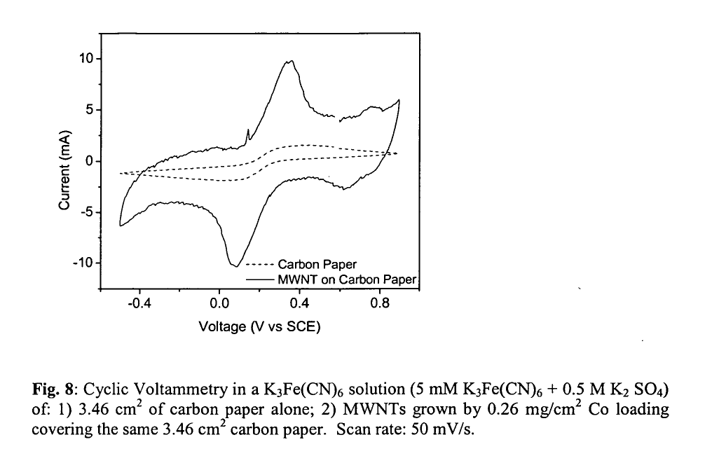

The surface area of the MWNT-carbon paper composite electrode was determined to be in the range between 80-140 m²/g from nitrogen adsorption by the Brunauer-Emmett-Teller method (Micromeritics ASAP 2010), while that of carbon paper alone is less than 2 m²/g. This is consistent with cyclic voltammetry (CV) measurements in potassium ferricyanide (III) solution (FIG. 8) where the redox current is much higher for the MWNT-carbon paper composite, further indicating that MWNTs are electrically connected to the carbon paper substrate.

### Example

### Adhesion of MWNTs to the Substrate

As disclosed above, one of the concerns for the application of MWNTs in PEMFCs is to ensure the strong adhesion of the MWNTs to the carbon paper so that they will remain on the surface of carbon paper during the subsequent procedure for Pt deposition and MEA preparation. To test this, the MWNT-carbon paper composite electrode was submerged into 50 mL of double distilled water and ultrasonicated. After an hour of sonication, there were no discernible black particles in the solution, suggesting a strong adhesion between MWNT and carbon paper.

### Example

### Preparation of an Membrane Electrode Assemblies (MEA)

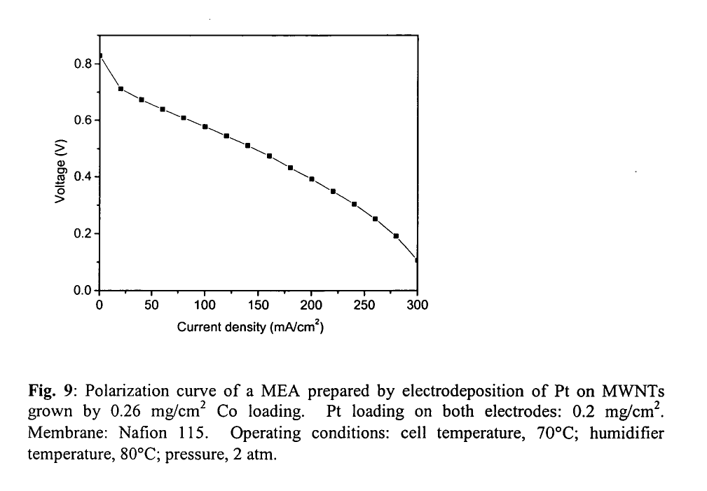

An exemplary MEA was prepared using two MWNT-carbon paper composite electrodes by first immersing the two electrodes into 5% commercial Nafion solution for 30 mins and subsequent hot pressing these two electrodes with a Nafion 115 membrane in between the two electrodes. The MWNTs were grown using a 0.26 mg/cm² Co loading. The performance (FIG. 9) of this MEA was tested using a fuel cell test station (ElectroChem. Inc., USA). The performance curve of FIG. 9 demonstrates the feasibility of electrodeposition of catalyst for MWNT growth directly on the carbon paper and subsequent electrodeposition of Pt on the MWNTs.

As will be understood by those skilled in the art, the present invention may be embodied in other specific forms without departing from the essential characteristics thereof. For example, steps may be combined or expanded during the formation of the MEAs. Or it is expected that once the yield and diameter of the MWNTs and the Pt particle sizes are optimized, the carbon nanotube based fuel cell will have an improved performance. These other embodiments are intended to be included within the scope of the present invention, which is set forth in the following claims.

What is claimed is:

1. A method of making a proton exchange fuel cell electrode, comprising:
forming carbon nanotubes on a substrate, to form a catalyst support;
depositing a precious metal on the nanotubes, to form a carbon nanotube supported catalyst; and
incorporating a polymer membrane into the spaces between the carbon nanotube supported catalyst, to form the electrode.

2. The method of claim 1 wherein said forming comprises forming carbon nanotubes on a gas diffusion layer substrate.

3. The method of claim 1 wherein said forming comprises forming single walled carbon nanotubes.

4. The method of claim 1 wherein said forming comprises forming multi-walled carbon nanotubes.

5. The method of claim 1 wherein said forming comprises preparing an array of anodic porous alumina templates on a substrate before said forming, to form an aligned array of carbon nanotubes.

6. The method of claim 5 comprising preparing an array of anodic porous alumina templates on a porous silicon substrate before said forming, to form an aligned array of carbon nanotubes.

7. The method of claim 1 wherein said forming comprises growing carbon nanotubes on the substrate using a chemical vapor deposition process using acetylene in nitrogen as a carbon source.

8. The method of claim 7 wherein said forming comprises growing boron dopes carbon nanotubes on the substrate using a chemical vapor deposition process using acetylene in nitrogen as a carbon source.

9. The method of claim 1 wherein said forming comprises directly growing carbon nanotubes on a carbon substrate using a chemical vapor deposition process.

10. The method of claim 9 wherein said forming comprises depositing a catalyst selected from the group consisting of cobalt, iron, boron, and combinations thereof, on the carbon substrate, for catalyzing the growing of the carbon nanotubes.

11. The method of claim 10 wherein said depositing cobalt comprises electrodepositing on one side of the carbon substrate by a three-electrode dc method in a 5 wt. % CoSO₄ and 2 wt. % H₃BO₃ aqueous solution at 20° C.

12. The method of claim 11 wherein the cobalt loading is between none and 20 mg/m².

13. The method of claim 12 wherein the size of the deposited catalyst particles is a function of the catalyst loading, such that an increase in catalyst loading produces larger cobalt particles.

14. The method of claim 10 wherein said forming comprises using a chemical vapor deposition process using acetylene in nitrogen as a carbon source.

15. The method of claim 1 wherein said depositing comprises depositing a metal selected from the group consisting of platinum, gold, other precious metals, and combinations thereof.

16. The method of claim 1 wherein said depositing comprises surface functionalizing the surface of the nanotubes through a chemical oxidation treatment and depositing the precious metal by an incipient-wetness process.

17. The method of claim 1 wherein said depositing comprises an electrodeposition process.

18. The method of claim 17 wherein the electrodeposition process comprises electrodepositing platinum on the nanotubes by a three-electrode dc method in 5 mM H₂PtCl₆ and 0.5 M H₂SO₄ aqueous solution.

19. The method of claim 1 wherein said incorporating a polymer membrane comprises depositing a solubilized perfluorosulfonate ionomer into the spare space between nanotubes to form a 4-phase boundary.

20. The method of claim 1 further comprising forming a proton exchange membrane fuel cell utilizing the formed electrode, comprising:
adding a proton conducting membrane; and
adding electron collectors having fuel flow fields, to form the proton exchange membrane fuel cell.
